(19) United States
(12) Patent Application Publication
(10) Pub. No.: US 2020/0333620 A1
(43) Pub. Date: Oct. 22, 2020

(54) IMAGING SYSTEM

(71) Applicant: QISDA CORPORATION, Taoyuan City (TW)

(72) Inventors: Ming-Kuen Lin, Taoyuan City (TW); Tsung-Hsun Wu, Taoyuan City (TW)

(21) Appl. No.: 16/831,761

(22) Filed: Mar. 26, 2020

(30) Foreign Application Priority Data
Apr. 16, 2019 (CN) 201910302989.4

(51) Int. Cl. G02B 27/64; G02B 27/10; G02B 5/08

(52) U.S. Cl. CPC G02B 27/642; G02B 5/08; G02B 27/10

(57) ABSTRACT

An imaging system includes an image generating device, a first reflecting mirror, a second reflecting mirror, and an image combiner. The image generating device projects a light onto the first reflecting mirror along a first optical path. The first optical path is reflected by the first reflecting mirror to form a second optical path. An angle included between the first optical path and a normal of the first reflecting mirror is smaller than 45 degrees. The second optical path is reflected by the second reflecting mirror to form a third optical path. An angle included between the second optical path and a normal of the second reflecting mirror is smaller than 45 degrees. The third optical path forms a virtual image through the image combiner. An angle included between the third optical path and a normal of the image combiner is smaller than 45 degrees.

### BACKGROUND OF THE INVENTION

### 1. Field of the Invention

The invention relates to an imaging system and, more particularly, to an imaging system capable of enlarging a field of view effectively.

### 2. Description of the Prior Art

A head up display (HUD) is used to project specific information onto a glass by optical reflection principle for a user. At present, some vehicles have been equipped with the head up display. The volume of the head up display cannot be too large due to the limitation of space inside the vehicle. However, if the volume of the head up display is small (i.e. the components therein are small), a field of view (FOV) generated by the head up display is small correspondingly, such that the application of the head up display is limited.

### SUMMARY OF THE INVENTION

An objective of the invention is to provide an imaging system capable of enlarging a field of view effectively, so as to solve the aforesaid problems.

According to an embodiment of the invention, an imaging system comprises an image generating device, a first reflecting mirror, a second reflecting mirror and an image combiner. The first reflecting mirror is disposed with respect to the image generating device. The image generating device projects a light onto the first reflecting mirror along a first optical path. The first optical path is reflected by the first reflecting mirror to form a second optical path. An angle included between the first optical path and a normal of the first reflecting mirror is smaller than 45 degrees. The second reflecting mirror is disposed with respect to the first reflecting mirror. The second optical path is reflected by the second reflecting mirror to forma third optical path. An angle included between the second optical path and a normal of the second reflecting mirror is smaller than 45 degrees. The image combiner is disposed with respect to the second reflecting mirror. The third optical path forms a virtual image through the image combiner. An angle included between the third optical path and a normal of the image combiner is smaller than 45 degrees.

As mentioned in the above, the invention uses the first reflecting mirror and the second reflecting mirror to reflect the light projected by the image generating device to the image combiner, such that the image combiner forms the virtual image. Since the angle included between the first optical path and the normal of the first reflecting mirror is smaller than 45 degrees, the angle included between the second optical path and the normal of the second reflecting mirror is smaller than 45 degrees, and the angle included between the third optical path and the normal of the image combiner is smaller than 45 degrees, the invention can enlarge the field of view effectively without increase the volume of the imaging system, such that the imaging system can be used more widely.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic view illustrating an imaging system according to an embodiment of the invention.

FIG. 2 is a schematic view illustrating a footprint related to an angle smaller than 45 degrees.

FIG. 3 is a schematic view illustrating a footprint related to an angle larger than 45 degrees.

FIG. 4 is a schematic view illustrating an imaging system according to another embodiment of the invention.

### DETAILED DESCRIPTION

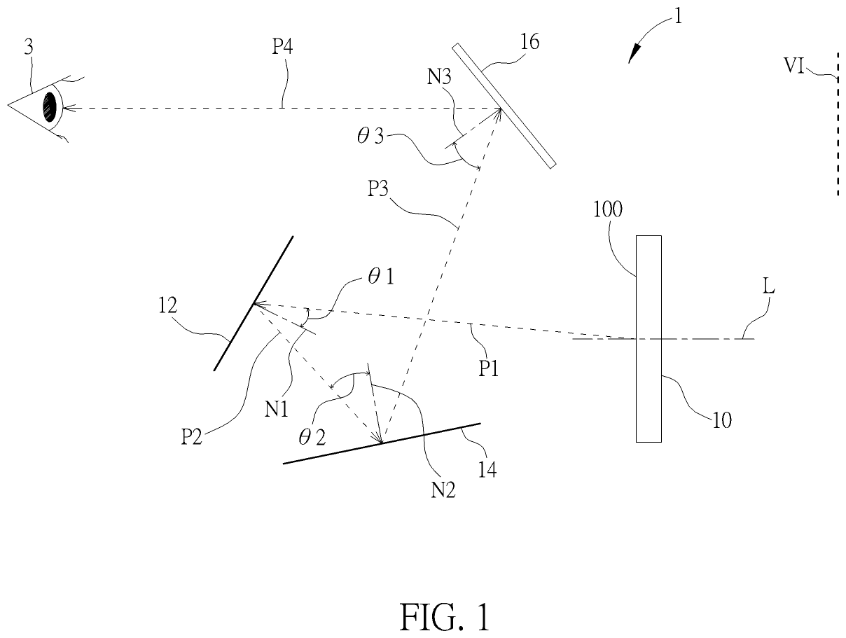

Referring to FIG. 1, FIG. 1 is a schematic view illustrating an imaging system 1 according to an embodiment of the invention. As shown in FIG. 1, the imaging system 1 comprises an image generating device 10, a first reflecting mirror 12, a second reflecting mirror 14 and an image combiner 16. In this embodiment, the imaging system 1 may be, but not limited to, a head up display or an enlarged display. The image generating device 10 may be a display, a mobile phone or other electronic devices capable of generating images. The first reflecting mirror 12 and the second reflecting mirror 14 may be aspherical reflecting mirrors. The image combiner 16 may be a reflecting mirror or a transflective (half-refection and half-transmission) component. When the image combiner 16 is a transflective component, the transmittance and the reflectance of the image combiner 16 may be adjusted by optical coating technology. For example, when the imaging system 1 is a head up display, the image combiner 16 may be a windshield of a vehicle and the transmittance of the image combiner 16 may be larger than the reflectance thereof, such that the imaging system 1 may be applied to an application of augmented reality (AR). Furthermore, when the imaging system 1 is an enlarged display (e.g. China Patent No. 208000411U), the reflectance of the image combiner 16 may be larger than the transmittance thereof, such that the imaging system 1 may be applied to an application of virtual reality (VR).

As shown in FIG. 1, the first reflecting mirror 12 is disposed with respect to the image generating device 10, the second reflecting mirror 14 is disposed with respect to the first reflecting mirror 12, and the image combiner 16 is disposed with respect to the second reflecting mirror 14. When the image generating device 10 is powered on, the image generating device 10 projects a light onto the first reflecting mirror 12 along a first optical path P1. Then, the first optical path P1 is reflected by the first reflecting mirror 12 to form a second optical path P2. Then, the second optical path P2 is reflected by the second reflecting mirror 14 to form a third optical path P3. Finally, the third optical path P3 forms a virtual image VI through the image combiner 16 and the third optical path P3 is reflected by the image combiner 16 to an eye 3 of a person to form a fourth optical path P4.

In this embodiment, a light projection surface 100 of the image generating device 10 may be perpendicular to a level L, such that the light projection surface 100 of the image generating device 10 is substantially parallel to the virtual image VI. Furthermore, by means of the arrangement between the first reflecting mirror 12, the second reflecting mirror 14 and the image combiner 16, the image generating device 10 and the virtual image VI may be located at identical side of the image combiner 16, and the eye 3 and the image generating device 10 may be located at opposite sides of the image combiner 16.

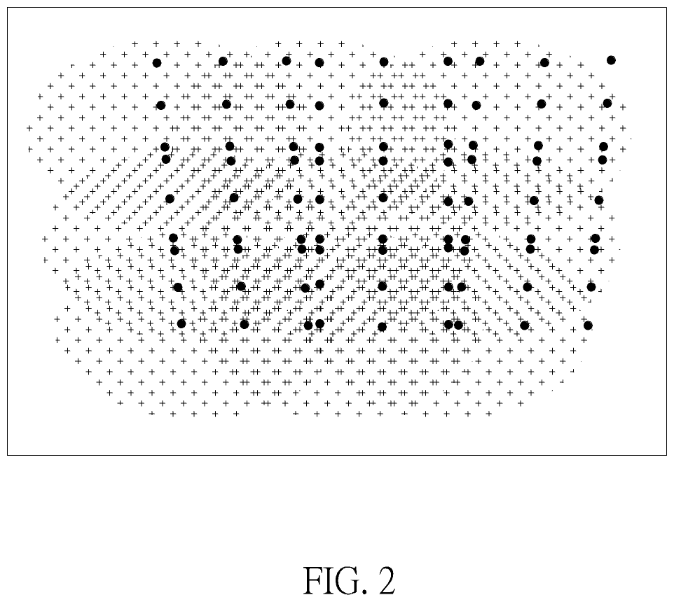

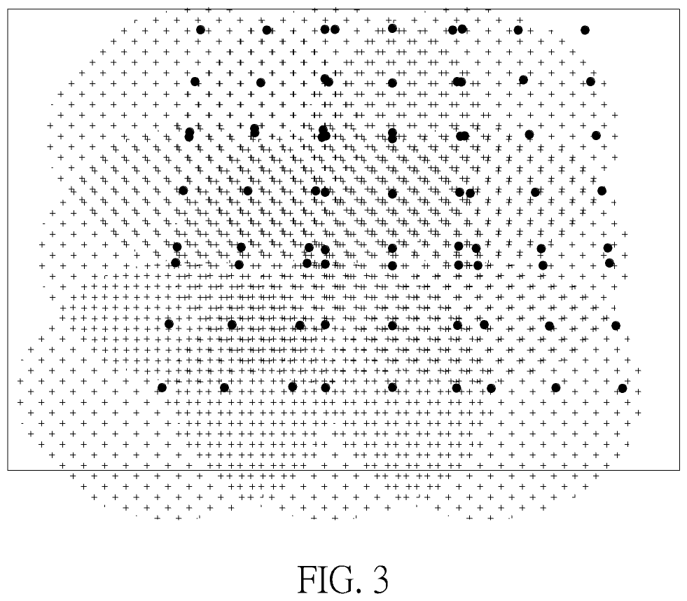

In this embodiment, an angle θ1 included between the first optical path P1 and a normal N1 of the first reflecting mirror 12 is smaller than 45 degrees, an angle θ2 included between the second optical path P2 and a normal N2 of the second reflecting mirror 14 is smaller than 45 degrees, and an angle θ3 included between the third optical path P3 and a normal N3 of the image combiner 16 is smaller than 45 degrees. Accordingly, the invention reduces the size of footprint (i.e. light projection area) on the first reflecting mirror 12, the second reflecting mirror 14 and the image combiner 16, such as the footprint shown in FIG. 2 is smaller than the footprint shown in FIG. 3. Therefore, the invention can provide the same field of view by small components to miniaturize the imaging system 1, such that the imaging system 1 can be used more widely.

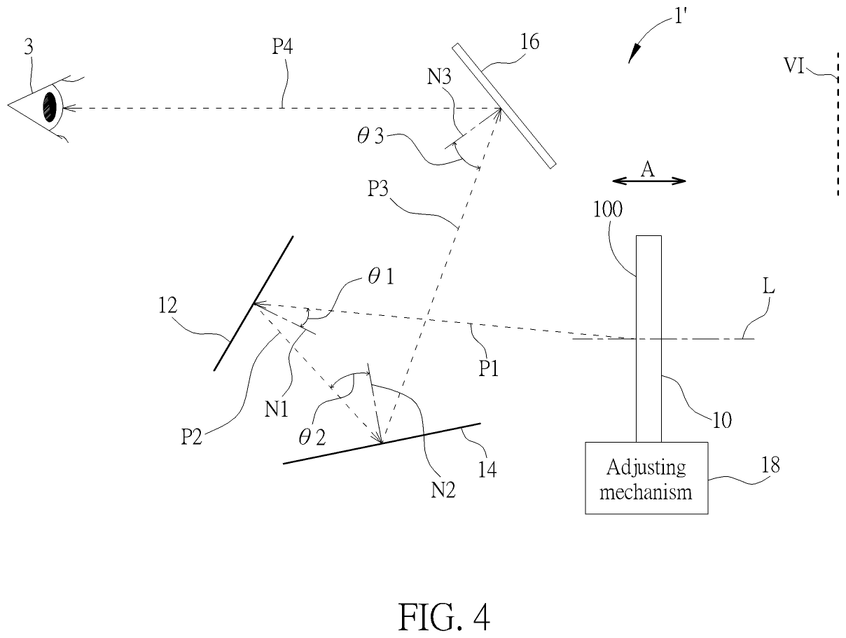

Referring to FIG. 4, FIG. 4 is a schematic view illustrating an imaging system 1′ according to another embodiment of the invention. The main difference between the imaging system 1′ and the aforesaid imaging system 1 is that the imaging system 1′ further comprises an adjusting mechanism 18, as shown in FIG. 4. In this embodiment, the adjusting mechanism 18 is connected to the image generating device 10 and the adjusting mechanism 18 is configured to drive the image generating device 10 to move away from or toward the first reflecting mirror 12 (i.e. move along a direction indicated by a double-headed arrow A). Accordingly, a user may control the adjusting mechanism 18 to drive the image generating device 10 to move away from or toward the first reflecting mirror 12, so as to adjust a size of the virtual image VI and a distance between the virtual image VI and the eye 3. Since the light projection surface 100 of the image generating device 10 is substantially parallel to the virtual image VI, the virtual image VI does not deform while the image generating device 10 is moving. In this embodiment, the adjusting mechanism 18 may consist of motor, linkage, gear, rack and/or other linking components according to practical applications.

As mentioned in the above, the invention uses the first reflecting mirror and the second reflecting mirror to reflect the light projected by the image generating device to the image combiner, such that the image combiner forms the virtual image. Since the angle included between the first optical path and the normal of the first reflecting mirror is smaller than 45 degrees, the angle included between the second optical path and the normal of the second reflecting mirror is smaller than 45 degrees, and the angle included between the third optical path and the normal of the image combiner is smaller than 45 degrees, the invention can enlarge the field of view effectively without increase the volume of the imaging system, such that the imaging system can be used more widely. Furthermore, the invention may use the adjusting mechanism to drive the image generating device to move, so as to adjust the size of the virtual image and the distance between the virtual image and the eye.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An imaging system comprising:
an image generating device;
a first reflecting mirror disposed with respect to the image generating device, the image generating device projecting a light onto the first reflecting mirror along a first optical path, the first optical path being reflected by the first reflecting mirror to form a second optical path, an angle included between the first optical path and a normal of the first reflecting mirror being smaller than 45 degrees;
a second reflecting mirror disposed with respect to the first reflecting mirror, the second optical path being reflected by the second reflecting mirror to form a third optical path, an angle included between the second optical path and a normal of the second reflecting mirror being smaller than 45 degrees; and
an image combiner disposed with respect to the second reflecting mirror, the third optical path forming a virtual image through the image combiner, an angle included between the third optical path and a normal of the image combiner being smaller than 45 degrees.

2. The imaging system of claim 1, wherein the image generating device and the virtual image are located at identical side of the image combiner.

3. The imaging system of claim 1, wherein a light projection surface of the image generating device is perpendicular to a level.

4. The imaging system of claim 1, wherein the image combiner is a reflecting mirror.

5. The imaging system of claim 1, wherein the image combiner is a transflective component.

6. The imaging system of claim 1, further comprising an adjusting mechanism connected to the image generating device, the adjusting mechanism driving the image generating device to move away from or toward the first reflecting mirror.
